(19) United States
(12) Patent Application Publication
(10) Pub. No.: US 2024/0077985 A1
(43) Pub. Date: Mar. 7, 2024

(54) Applying Spatial Restrictions to Data in an Electronic Device

(71) Applicant: Apple Inc., Cupertino, CA (US)

(72) Inventors: Divya T. Ramakrishnan, Los Altos, CA (US); Brandon J. Van Ryswyk, Los Altos, CA (US); Reinhard Klapfer, San Bruno, CA (US); Antti P. Saarinen, Jarvenpaa (FI); Kyle L. Simek, Sunnyvale, CA (US); Aitor Aldoma Buchaca, Munich (DE); Tobias Böttger-Brill, Munich (DE); Robert Maier, Munich (DE); Ming Chuang, Bellevue, WA (US)

(21) Appl. No.: 18/339,104

(22) Filed: Jun. 21, 2023

Related U.S. Application Data
(60) Provisional application No. 63/404,002, filed on Sep. 6, 2022.

(51) Int. Cl. G06F 3/04815; G01B 11/02; G06F 3/04842; G06T 7/593

(52) U.S. Cl. CPC G06F 3/04815; G01B 11/026; G06F 3/04842; G06T 7/593

(57) ABSTRACT

An electronic device may include one or more sensors that capture sensor data for a physical environment around the electronic device. The sensor data may be used to determine a scene understanding data set for an extended reality environment including the electronic device. The scene understanding data set may include information such as spatial information, information regarding physical objects in the extended reality environment, and information regarding virtual objects in the extended reality environment. When providing scene understanding data to one or more applications running on the electronic device, spatial and/or temporal restrictions may be applied to the scene understanding data set. Scene understanding data that is associated with locations within a boundary and that is associated with times after a cutoff time may be provided to an application.

This application claims priority to U.S. provisional patent application No. 63/404,002, filed Sep. 6, 2022, which is hereby incorporated by reference herein in its entirety.

### BACKGROUND

This relates generally to electronic devices, and, more particularly, to electronic devices with one or more sensors.

Some electronic devices include sensors for obtaining sensor data for a physical environment around the electronic device. The electronic device may run one or more applications that use the sensor data. If care is not taken, more sensor data than is desired may be shared with applications running on the electronic device.

### SUMMARY

A method of operating an electronic device with one or more sensors in a physical environment may include obtaining, using the one or more sensors, sensor data for the physical environment, determining a first data set for a three-dimensional environment using at least the sensor data, running an application, generating a second data set from the first data set based on spatial restrictions, and providing only the second data set to the application.

A method of operating an electronic device may include obtaining a first data set for a three-dimensional environment around the electronic device, based on an application running on the electronic device, using the first data set to obtain a second data set by only including, in the second data set, data for portions of the three-dimensional environment associated with locations within a boundary, and providing the second data set to the application.

An electronic device operable in a physical environment may include a head-mounted support structure, one or more sensors coupled to the head-mounted support structure and configured to obtain sensor data for the physical environment, and control circuitry configured to determine a first data set for a three-dimensional environment using at least the sensor data, generate a second data set from the first data set based on spatial restrictions, and provide only the second data set to an application.

### BRIEF DESCRIPTION OF THE DRAWINGS

FIG. 1 is a schematic diagram of an illustrative electronic device in accordance with some embodiments.

FIG. 2 is a top view of an extended reality environment including an electronic device, physical objects, and virtual objects in accordance with some embodiments.

FIG. 3 is a top view of an extended reality environment where an electronic device applies a boundary having a fixed radius to scene understanding data in accordance with some embodiments.

FIG. 4 is a top view of an extended reality environment where an electronic device applies a boundary that is based on a fixed radius and an occupied room to scene understanding data in accordance with some embodiments.

FIG. 5 is a top view of an extended reality environment where an electronic device applies a boundary that is based on an occupied room to scene understanding data in accordance with some embodiments.

FIG. 6 is a top view of an extended reality environment where an electronic device applies a boundary that is based on line-of-sight distances to scene understanding data in accordance with some embodiments.

FIG. 7 is a top view of an extended reality environment where an electronic device applies a boundary and exclusion regions to scene understanding data in accordance with some embodiments.

FIG. 8 is a top view of an extended reality environment where an electronic device maintains scene understanding data in discrete groups in accordance with some embodiments.

FIG. 9 is a schematic diagram showing how different restrictions may be applied to data provided to first and second applications running on an electronic device in accordance with some embodiments.

FIG. 10 is a flowchart showing an illustrative method performed by an electronic device in accordance with some embodiments.

### DETAILED DESCRIPTION

Head-mounted devices may display different types of extended reality (XR) content for a user. The head-mounted device may display a virtual object that is perceived at an apparent depth within the physical environment of the user. Virtual objects may sometimes be displayed at fixed locations relative to the physical environment of the user. For example, consider an example where a user's physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as world-locked content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user's head), the virtual object remains in a fixed position relative to the head-mounted device. For example, the virtual object may be displayed in the front and center of the head-mounted device (e.g., in the center of the device's or user's field-of-view) at a particular distance. As the user moves their head left and right, their view of their physical environment changes accordingly. However, the virtual object may remain fixed in the center of the device's or user's field of view at the particular distance as the user moves their head (assuming gaze direction remains constant). This type of content may be referred to as head-locked content. The head-locked content is fixed in a given position relative to the head-mounted device (and therefore the user's head which is supporting the head-mounted device). The head-locked content may not be adjusted based on a user's gaze direction. In other words, if the user's head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user's torso). This type of content may be referred to as body-locked content. For example, a virtual object may be displayed in front and to the left of a user's body (e.g., at a location defined by a distance and an angular offset from a forward-facing direction of the user's torso), regardless of which direction the user's head is facing. If the user's body is facing a first direction, the virtual object will be displayed in front and to the left of the user's body. While facing the first direction, the virtual object may remain at the same, fixed position relative to the user's body in the XR environment despite the user rotating their head left and right (to look towards and away from the virtual object). However, the virtual object may move within the device's or user's field of view in response to the user rotating their head. If the user turns around and their body faces a second direction that is the opposite of the first direction, the virtual object will be repositioned within the XR environment such that it is still displayed in front and to the left of the user's body. While facing the second direction, the virtual object may remain at the same, fixed position relative to the user's body in the XR environment despite the user rotating their head left and right (to look towards and away from the virtual object).

In the aforementioned example, body-locked content is displayed at a fixed position/orientation relative to the user's body even as the user's body rotates. For example, the virtual object may be displayed at a fixed distance in front of the user's body. If the user is facing north, the virtual object is in front of the user's body (to the north) by the fixed distance. If the user rotates and is facing south, the virtual object is in front of the user's body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user's body at a fixed distance from the user as the user faces north. If the user rotates and is facing south, the virtual object remains to the north of the user's body at the fixed distance from the user's body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

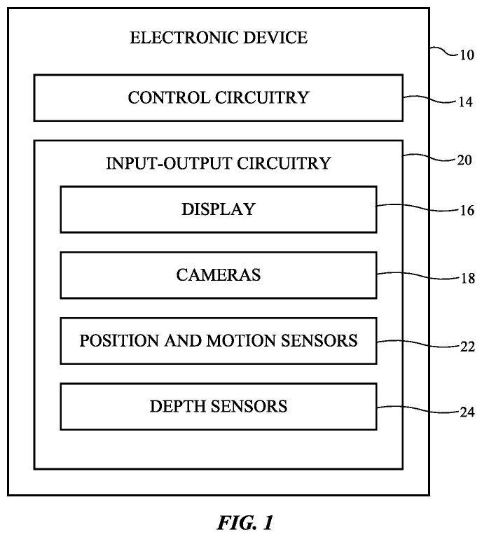

An illustrative electronic device is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a display, a computer display that contains an embedded computer, a computer display that does not contain an embedded computer, a gaming device, a navigation device, an embedded system such as a system in which electronic equipment with a display is mounted in a kiosk or automobile, or other electronic equipment. Electronic device 10 may have the shape of a pair of eyeglasses (e.g., supporting frames), may form a housing having a helmet shape, or may have other configurations to help in mounting and securing the components of one or more displays on the head or near the eye of a user.

As shown in FIG. 1, electronic device 10 (sometimes referred to as head-mounted device 10, system 10, head-mounted display 10, etc.) may have control circuitry 14. Control circuitry 14 may be configured to perform operations in electronic device 10 using hardware (e.g., dedicated hardware or circuitry), firmware and/or software. Software code for performing operations in electronic device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Electronic device 10 may include input-output circuitry 20. Input-output circuitry 20 may be used to allow data to be received by electronic device 10 from external equipment (e.g., a tethered computer, a portable device such as a handheld device or laptop computer, or other electrical equipment) and to allow a user to provide electronic device 10 with user input. Input-output circuitry 20 may also be used to gather information on the environment in which electronic device 10 is operating. Output components in circuitry 20 may allow electronic device 10 to provide a user with output and may be used to communicate with external electrical equipment.

As shown in FIG. 1, input-output circuitry 20 may include a display such as display 16. Display 16 may be used to display images for a user of electronic device 10. Display 16 may be a transparent display so that a user may observe physical objects through the display while computer-generated content is overlaid on top of the physical objects by presenting computer-generated images on the display. A transparent display may be formed from a transparent pixel array (e.g., a transparent organic light-emitting diode display panel) or may be formed by a display device that provides images to a user through a beam splitter, holographic coupler, or other optical coupler (e.g., a display device such as a liquid crystal on silicon display). Alternatively, display 16 may be an opaque display that blocks light from physical objects when a user operates electronic device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 16 is opaque, the display may also optionally display entirely computer-generated content (e.g., without displaying images of the physical environment).

Display 16 may include one or more optical systems (e.g., lenses) (sometimes referred to as optical assemblies) that allow a viewer to view images on display(s) 16. A single display 16 may produce images for both eyes or a pair of displays 16 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 20 may include various other input-output devices. For example, input-output circuitry 20 may include one or more cameras 18. Cameras 18 may include one or more outward-facing cameras (that face the physical environment around the user when the electronic device is mounted on the user's head, as one example). Cameras 18 may capture visible light images, infrared images, or images of any other desired type. The cameras may be stereo cameras if desired. Outward-facing cameras may capture pass-through video for device 10.

As shown in FIG. 1, input-output circuitry 20 may include position and motion sensors 22 (e.g., compasses, gyroscopes, accelerometers, and/or other devices for monitoring the location, orientation, and movement of electronic device 10, satellite navigation system circuitry such as Global Positioning System circuitry for monitoring user location, etc.). Using sensors 22, for example, control circuitry 14 can monitor the current direction in which a user's head is oriented relative to the surrounding environment (e.g., a user's head pose). The outward-facing cameras in cameras 18 may also be considered part of position and motion sensors 22. The outward-facing cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 20 may include one or more depth sensors 24. Each depth sensor may be a pixelated depth sensor (e.g., that is configured to measure multiple depths across the physical environment) or a point sensor (that is configured to measure a single depth in the physical environment). Each depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 20 may also include other sensors and input-output components if desired (e.g., gaze tracking sensors, ambient light sensors, force sensors, temperature sensors, touch sensors, image sensors for detecting hand gestures or body poses, buttons, capacitive proximity sensors, light-based proximity sensors, other proximity sensors, strain gauges, gas sensors, pressure sensors, moisture sensors, magnetic sensors, microphones, speakers, audio components, haptic output devices such as actuators, light-emitting diodes, other light sources, wired and/or wireless communications circuitry, etc.).

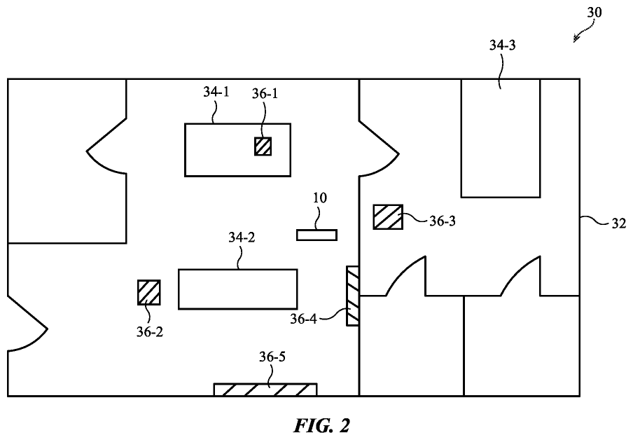

FIG. 2 is a top view of an illustrative three-dimensional environment that includes electronic device 10. In FIG. 2, three-dimensional environment 30 is an extended reality (XR) environment that includes both the physical environment around electronic device 10 (with various physical objects) and virtual objects. XR environment 30 may include a plurality of physical walls 32 that define several rooms (e.g., rooms in a house or apartment). There are five rooms in the example XR environment of FIG. 2. The physical environment around electronic device 10 may include physical objects such as physical object 34-1, 34-2, and 34-3. The physical objects depicted in FIG. 2 may be any desired type of physical objects (e.g., a table, a bed, a sofa, a chair, a refrigerator, etc.).

In addition to physical objects, extended reality environment 30 includes virtual objects such as virtual objects 36-1, 36-2, 36-3, 36-4, and 36-5. The virtual objects may include two-dimensional virtual objects and/or three-dimensional virtual objects. The virtual objects may include world-locked virtual objects, head-locked virtual objects, and/or body-locked virtual objects. In the example of FIG. 2, virtual objects 36-4 and 36-5 may be world-locked two-dimensional objects (e.g., that are positioned to appear on physical walls 32 to simulate photographs or posters on the physical walls). Virtual objects 36-1, 36-2, and 36-3 may be world-locked three-dimensional objects. Three-dimensional virtual object 36-1 may be, for example, positioned to appear on an upper surface of physical object 34-1.

During the operation of electronic device 10, electronic device 10 may move throughout three-dimensional environment 30. In other words, a user of electronic device 10 may repeatedly carry electronic device 10 between different rooms in three-dimensional environment 30. While operating in three-dimensional environment 30, the electronic device 10 may use one or more sensors (e.g., cameras 18, position and motion sensors 22, depth sensors 24, etc.) to gather sensor data regarding the three-dimensional environment 30. The electronic device 10 may build a scene understanding data set for the three-dimensional environment.

To build the scene understanding data set, the electronic device may use inputs from sensors such as cameras 18, position and motion sensors 22, and depth sensors 24. As one example, data from the depth sensors 24 and/or position and motion sensors 22 may be used to construct a spatial mesh that represents the physical environment. The spatial mesh may include a polygonal model of the physical environment and/or a series of vertices that represent the physical environment. The spatial mesh (sometimes referred to as spatial data, etc.) may define the sizes, locations, and orientations of planes within the physical environment. The spatial mesh represents the physical environment around the electronic device.

Other data such as data from cameras 18 may be used to build the scene understanding data set. For example, camera 18 may capture images of the physical environment. The electronic device may analyze the images to identify a property of a plane in spatial mesh (e.g., the color of a plane). The property may be included in the scene understanding data set.

The scene understanding data set may include identities for various physical objects in the extended reality environment. For example, electronic device 10 may analyze images from camera 18 and/or depth sensors 24 to identify physical objects. The electronic device 10 may identify physical objects such as a bed, a couch, a chair, a table, a refrigerator, etc. This information identifying physical objects may be included in the scene understanding data set.

The scene understanding data set may also include information regarding various virtual objects in the extended reality environment. Electronic device 10 may be used to display the virtual objects and therefore knows the identities, sizes, shapes, colors, etc. for virtual objects in the extended reality environment. This information regarding virtual objects may be included in the scene understanding data set.

The scene understanding data set may be built on electronic device 10 over time as the electronic device moves throughout the extended reality environment. For example, consider an example where electronic device 10 starts in the room in FIG. 2 that includes physical objects 34-1 and 34-2. The electronic device may use depth sensors to obtain depth information (and develop the spatial mesh) for the currently occupied room (with objects 34-1/34-2). The electronic device may develop the scene understanding data set (including the spatial mesh, physical object information, virtual object information, etc.) for the currently occupied room. At this point, the electronic device has no information for the unoccupied rooms.

Next, the electronic device 10 may be transported into the room with physical object 34-3. While in this new room, the electronic device may use depth sensors to obtain depth information (and develop the spatial mesh) for the currently occupied room (with object 34-3). The electronic device may develop the scene understanding data set (including the spatial mesh, physical object information, virtual object information, etc.) for the currently occupied room. The electronic device now has a scene understanding data set including data on both the currently occupied room (with object 34-3) and the previously occupied room (with objects 34-1 and 34-2). In other words, data may be added to the scene understanding data set when the electronic device enters new portions of the three-dimensional environment. Therefore, over time (as the electronic device is transported to every room in the three-dimensional environment), the scene understanding data set includes data on the entire three-dimensional environment 30.

Electronic device 10 may maintain a scene understanding data set that includes all scene understanding data associated with extend reality environment 30 (e.g., including both a currently occupied room and currently unoccupied rooms). Electronic device 10 may wish to share scene understanding data with applications running on electronic device 10 in order to enable enhanced functionality on the applications. However, it may be desirable to provide an application running on electronic device 10 only a subset of the total scene understanding data available for extended reality environment. This may, as an example, prevent the application from receiving scene understanding data for currently unoccupied rooms and/or rooms that are no longer physically available (e.g., rooms behind closed doors).

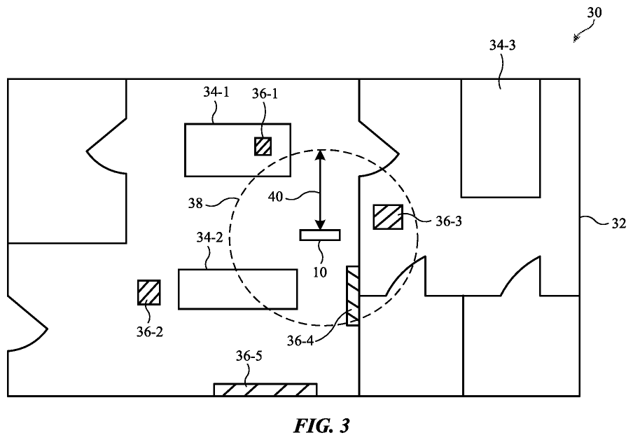

FIG. 3 is an example of how spatial restrictions may be applied to a scene understanding data set. As shown in FIG. 3, electronic device 10 may define a boundary 38 around electronic device 10. The electronic device may only provide scene understanding data for locations within boundary 38 to a given application running on the electronic device.

For example, a first subset of the spatial mesh within boundary 38 may be provided to the application whereas a second subset of the spatial mesh outside of boundary 38 may not be provided to the application. Information on physical objects within boundary 38 may be provided to the application whereas information on physical objects outside of boundary 38 may not be provided to the application. Information on virtual objects within boundary 38 may be provided to the application whereas information on virtual objects outside of boundary 38 may not be provided to the application.

Electronic device 10 may characterize an object (e.g., a virtual object or a physical object) as being within boundary 38 when a center of the object is within boundary 38, when a majority of the object is within boundary 38, or when any portion of the object is within boundary 38.

Consider an example where only information for objects that have centers within boundary 38 are provided to an application. Electronic device 10 may provide information regarding virtual objects 36-3 and 36-4 to the application (because virtual objects 36-3 and 36-4 have centers within boundary 38). Electronic device 10 may not provide information regarding virtual objects 36-1, 36-2, and 36-5 or physical objects 34-1, 34-2, and 34-3 to the application (because virtual objects 36-1, 36-2, and 36-5 and physical objects 34-1, 34-2, and 34-3 have centers outside of boundary 38).

Consider another example where only information for objects that have any portion within boundary 38 are provided to an application. Electronic device 10 may provide information regarding physical objects 34-1 and 34-2 and virtual objects 36-3 and 36-4 to the application (because physical objects 34-1 and 34-2 and virtual objects 36-3 and 36-4 have portions within boundary 38). Electronic device 10 may not provide information regarding virtual objects 36-1, 36-2, and 36-5 or physical object 34-3 to the application (because virtual objects 36-1, 36-2, and 36-5 and physical object 34-3 have no portions within boundary 38).

Boundary 38 may be a two-dimensional shape or a three-dimensional shape. Consider an example where boundary 38 in FIG. 3 has a two-dimensional (circular) shape. The boundary may be applied to the footprint of extended reality environment 30. Portions of the XR environment that overlap the footprint defined by boundary 38 may be considered within the boundary. Portions of the XR environment that do not overlap the footprint defined by boundary 38 may be considered outside of the boundary.

In another example, boundary 38 in FIG. 3 has a three-dimensional (spherical) shape. The boundary may be applied to the three-dimensional space within extended reality environment 30. Scene understanding data for portions of the XR environment that are within the spherical boundary may be provided to an application whereas scene understanding data for portions of the XR environment that are not within the spherical boundary may not be provided to an application.

In FIG. 3, boundary 38 (e.g., a circular boundary or spherical boundary) is defined by a radius 40. Radius 40 may be any desired distance (e.g., more than 0.5 meters, more than 1 meter, more than 2 meters, more than 4 meters, more than 6 meters, more than 8 meters, more than 12 meters, more than 16 meters, more than 20 meters, less than 1 meter, less than 2 meters, less than 4 meters, less than 6 meters, less than 8 meters, less than 12 meters, less than 16 meters, less than 20 meters, between 2 meters and 12 meters, between 6 meters and 10 meters, etc.).

Different boundaries may be used for different applications running on electronic device 10. For example, a first application may be provided scene understanding data within a boundary defined by a first radius while a second application may be provided scene understanding data within a boundary defined by a second radius that is different than the first radius. In this way, more trusted applications and/or applications that require a wider range of scene understanding data may be provided with more scene understanding data (e.g., by using a larger radius for boundary 38).

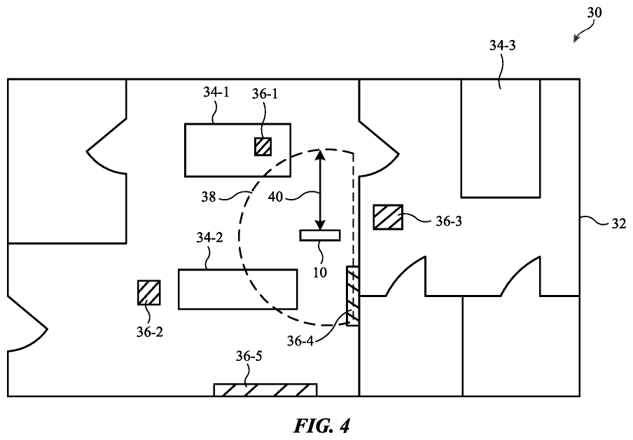

The shape of boundary 38 in FIG. 3 is merely illustrative. In general, boundary 38 may have any desired regular or irregular shape. FIG. 4 is an example of a boundary 38 with an irregular shape. As shown in FIG. 4, boundary 38 may again be characterized by a radius 40. However, the boundary may not extend past physical walls 32 within environment 30. In other words, the boundary may be limited to the room occupied by electronic device 10. Within radius 40, the boundary conforms to but does not extend past any physical walls. With this type of arrangement, an object such as virtual object 36-3 that is within radius 40 (as shown in FIG. 3) but in a different room than electronic device 10 is outside of boundary 38. This may prevent scene understanding information for an unoccupied room being sent to an application.

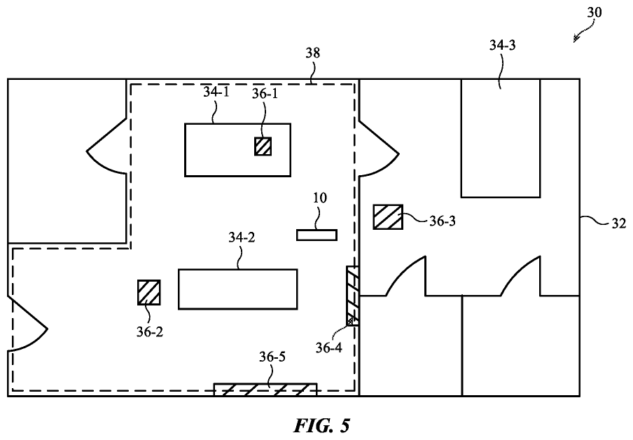

Another example for boundary 38 is shown in FIG. 5. In this example, boundary 38 may conform to the physical walls 32 of the room occupied by electronic device 10. In other words, scene understanding data for the occupied room is provided to an application while scene understanding data for all unoccupied rooms is not provided to the application.

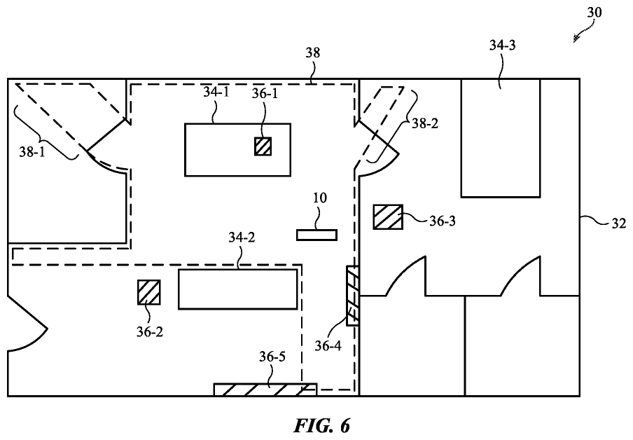

In yet another example, shown in FIG. 6, real-time depth sensing may be used to determine line-of-sight distances to the physical environment around electronic device 10. This type of scheme may be used to generate a boundary that simulates the actual field-of-view of a user of electronic device. As shown in FIG. 6, the user may be able to see through open doors in the physical environment. Accordingly, boundary 38 includes portions 38-1 and 38-2 with portions visible through the open doors from the perspective of electronic device 10. The user may not be able to see through certain physical objects in XR environment 30. For example, physical object 34-2 may obstruct the field-of-view of the user. Boundary 38 therefore reflects the obstruction to the field-of-view caused by physical object 34-2 (e.g., the lower-left corner of the occupied room is not included within boundary 38 due to the obstruction caused by physical object 34-2).

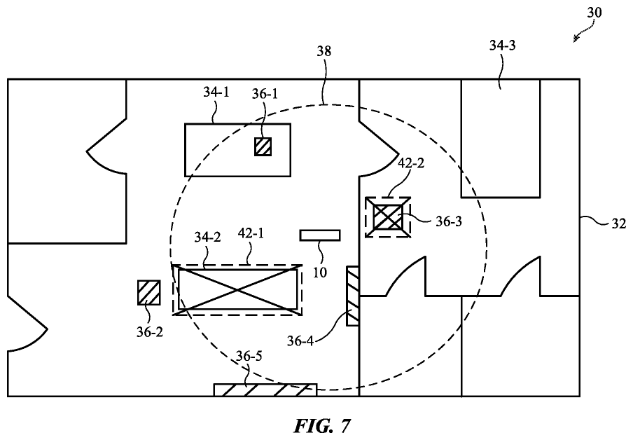

The size and shape of boundary 38 may be determined, at least in part, based on user input. For example, the user may select a boundary based on radius only (as in FIG. 3), based on radius while excluding data from unoccupied rooms (as in FIG. 4), based on the occupied room only (as in FIG. 5), or based on line-of-sight distances (as in FIG. 6). Furthermore, the user may add various exceptions to the boundary 38 if desired. FIG. 7 shows an example where exceptions are manually added to the boundary 38 by a user. As shown in FIG. 7, the user may block out region 42-1 and 42-2 from being included in the shared scene understanding data. Therefore, any scene understanding data associated with regions 42-1 and 42-2 is not provided to an application.

The exception regions may be defined by the user using an object (e.g., the user may preclude a particular physical object or a particular virtual object from being included in the scene understanding data provided to an application) or using a portion of three-dimensional space in the XR environment (e.g., the user may preclude information for a given area from being included in the scene understanding data provided to an application, regardless of whether the given area includes a physical object and/or a virtual object). For example, the user may identify virtual object 36-3 and physical object 34-2 in FIG. 7 as exceptions where no corresponding scene understanding data will be provided to an application. Even if the identified objects move in the XR environment, no corresponding scene understanding data for the objects will be provided to an application. As another example, the user may identify a given room as an exception where no corresponding scene understanding data will be provided to an application (regardless of whether physical objects and/or virtual objects are located in the room).

In addition to exception regions, the user may manually identify authorized regions within the XR environment. Available scene understanding data for the authorized regions may always be provided to an application, regardless of the user's real-time position. The authorized regions may be defined using an object or using a portion of three-dimensional space in the XR environment.

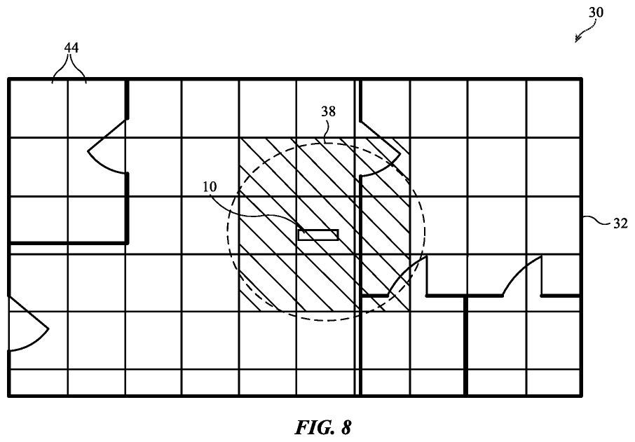

As shown in FIG. 8, the scene understanding data may be separated into a plurality of discrete groups 44. Each group may be associated with a respective portion of XR environment 30. Each group may be, for example, a cube. This example is merely illustrative. In general, each group may have any desired shape. Grouping the scene understanding data may mitigate the processing power required to filter the scene understanding data provided to an application based on a boundary. In the example of FIG. 8, the centroid of each group 44 is compared to boundary 38. If the centroid is within boundary 38, scene understanding data for the entire corresponding group 44 will be provided to the application on electronic device 10. If the centroid is outside boundary 38, scene understanding data for the entire corresponding group 44 will not be provided to the application on electronic device 10. In the example of FIG. 8, nine of the groups 44 have centroids within boundary 38. Scene understanding data associated with these nine groups is shared to the application running on electronic device 10.

In the example where groups 44 are cubes, the length of the cube may be any desired distance (e.g., more than 0.5 meters, more than 1 meter, more than 2 meters, more than 4 meters, more than 6 meters, more than 8 meters, more than 12 meters, more than 16 meters, more than 20 meters, less than 1 meter, less than 2 meters, less than 4 meters, less than 6 meters, less than 8 meters, less than 12 meters, less than 16 meters, less than 20 meters, between 0.5 meters and 10 meters, between 2 meters and 6 meters, etc.).

Binning the scene understanding data as in FIG. 8 may be used for any type of boundary 38. FIG. 8 shows an example with a boundary that has a fixed radius (as in FIG. 3). However, the binning may instead be used for any of the boundary types of FIGS. 4-7. Comparing the position of the centroid of a group of scene understanding data to the boundary is an efficient way to apply spatial restrictions to the full scene understanding data set. FIGS. 3-8 show examples of how spatial restrictions may be applied to a scene understanding data set when scene understanding data is provided to an application. Instead or in addition, temporal restrictions may be applied to a scene understanding data set when scene understanding data is provided to an application. For example, at a given instant in time t₃, there may be no physical objects within boundary 38. However, at a previous point in time t₁, there was a physical object within boundary 38. At t₃, the scene understanding data set stored in electronic device 10 may include information regarding the physical object at t₁. If no temporal restrictions are applied to the scene understanding data set, the information regarding the physical object at t₁ may be included in the data provided to an application at t₃. Temporal restrictions may be used to eliminate scene understanding data from before a cutoff time. Continuing the above example, the cutoff time may be t₂ between t₁ and t₃. If temporal restrictions are applied to the scene understanding data set, the information regarding the physical object at t₁ is not included in the data provided to an application at t₃ (because the data from t₁ is before the cutoff time t₂). Data from between t₂ and t₃, meanwhile, may be included in the data provided to the application.

Consider another scenario where a user transports electronic device 10 from a first point within the XR environment to a second point within the XR environment. There will be a first boundary 38 while the electronic device is at the first point and a second boundary 38 while the electronic device is at the second point. In one example, the electronic device 10 may only share (with an application) the scene understanding data within a real-time boundary 38. For example, the electronic device may only share (with an application) the scene understanding data within the first boundary while at the first point and may only share (with the application) the scene understanding data within the second boundary while at the second point.

In another example, the electronic device may share (with an application) the scene understanding data within a union of space including the real-time boundary and all previous boundaries within a given cutoff time. For example, the electronic device may share (with an application) the scene understanding data within the first boundary while at the first point and, subsequently, may share (with the application) the scene understanding data within the first boundary and within the second boundary while at the second point.

In general, applying temporal restrictions to the scene understanding data may include only providing scene understanding data to an application that is from after a cutoff time or may include only providing scene understanding data to an application that is from before a cutoff time.

Instead or in addition to spatial and/or temporal restrictions, semantic restrictions may be applied to a scene understanding data set when scene understanding data is provided to an application. In general, any desired type of restrictions may be used to filter scene understanding data provided to an application.

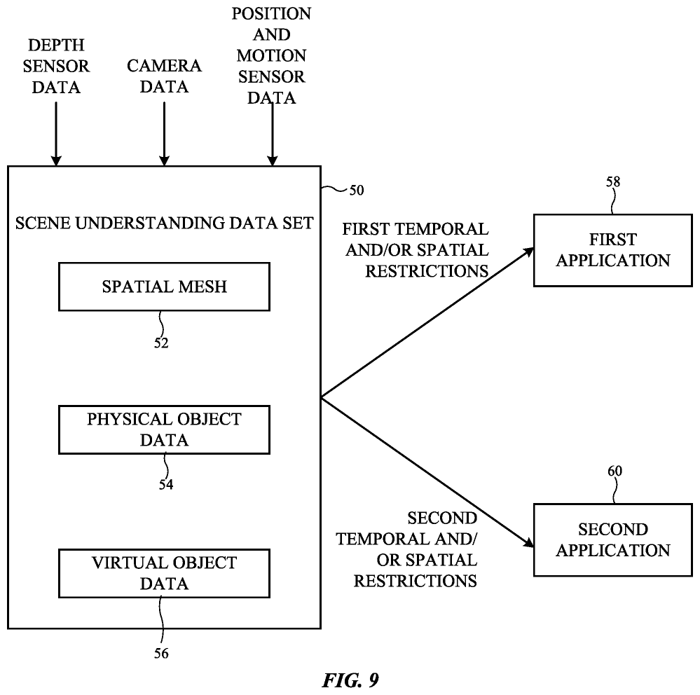

FIG. 9 is a schematic diagram showing how different restrictions may be applied to data provided to first and second respective applications running on an electronic device. As shown in FIG. 9, a scene understanding data set 50 may be built over time within the electronic device. The scene understanding data set 50 may be stored within memory of control circuitry 14 in electronic device 10. The scene understanding data set 50 may be generated at least in part using raw depth sensor data from depth sensors 24, raw camera data from cameras 18, and raw position and motion sensor data from position and motion sensors 22. In some cases, scene understanding data set 50 may include raw data from one or more sensors. Instead or in addition, the raw data may be processed (e.g., by control circuitry 14) and the processed data is stored in the scene understanding set.

As shown in FIG. 9, the scene understanding data set includes spatial mesh 52, physical object data 54, and virtual object 56. The spatial mesh 52 (sometimes referred to as spatial data or depth data) may be determined by processing raw data from depth sensors 24 and/or position and motion sensors 22. The physical object data may be determined by processing raw data from cameras 18. For example, images from the camera may be used to determine information regarding physical objects such as object color, object type, etc. Virtual object data 56 may be obtained from within memory in electronic device 10 (e.g., a scene graph or other representation of virtual objects within the XR environment).

Electronic device 10 may build the scene understanding data set over time (e.g., as a user moves from room to room in a physical environment). The stored scene understanding data may include scene understanding data for the entire three-dimensional environment 30.

In the example of FIG. 9, two applications are running on the electronic device. The applications may both benefit from scene understanding data to enhance the user experience. Accordingly, some of scene understanding data set 50 may be provided to the first application 58 and the second application 60.

First temporal and/or spatial restrictions may be applied to the scene understanding data provided to the first application 58. Second temporal and/or spatial restrictions (that are different than the first temporal and/or spatial restrictions) may be applied to the scene understanding data provided to the second application 60.

When installing and/or opening applications 58 and 60, the user of electronic device 10 may provide authorization to provide scene understanding data to the applications. When providing authorization to provide scene understanding data to the applications, the user may select a spatial boundary for the scene understanding data (e.g., a boundary based on radius only as in FIG. 3, based on radius while excluding data from unoccupied rooms as in FIG. 4, based on the occupied room only as in FIG. 5, or based on line-of-sight distances as in FIG. 6). The user may provide exceptions that are never shared with the applications (as in FIG. 7) or authorized regions that are always shared with the applications. Subsequently, when running an application, the previously selected restrictions for that application are applied to the spatial understanding data set to generate a second data set that is provided to that application.

For example, a user may select a boundary of a first radius (as in FIG. 3) for the first application when authorizing providing scene understanding data to the first application 58. The user may select a boundary of a second radius (as in FIG. 3) that is greater than the first radius for the second application when authorizing providing scene understanding data to the second application 60. The second application is therefore provided more scene understanding data than the first application.

As another example, a user may select a boundary based on the occupied room (as in FIG. 5) for the first application when authorizing providing scene understanding data to the first application 58. The user may select a boundary based on line-of-sight distances (as in FIG. 6) for the second application when authorizing providing scene understanding data to the second application 60.

The example of applications 58 and 60 running on electronic device 10 is merely illustrative. If desired, electronic device 10 may apply temporal and/or spatial restrictions to a scene understanding data set based on an application that is running on external electronic equipment (e.g., an additional electronic device). Electronic device 10 then provides the filtered scene understanding data to the application running on the external electronic equipment.

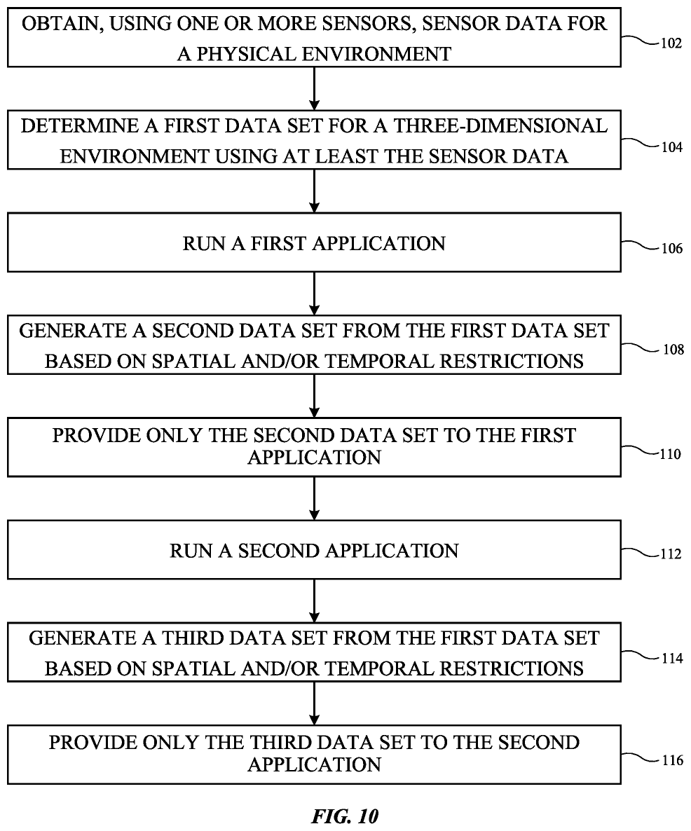

FIG. 10 is a flowchart showing an illustrative method performed by an electronic device (e.g., control circuitry 14 in device 10). The blocks of FIG. 10 may be stored as instructions in memory of electronic device 10, with the instructions configured to be executed by one or more processors in the electronic device.

During the operations of block 102, the electronic device may obtain, using one or more sensors, sensor data for a physical environment surrounding the electronic device. The one or more sensors may include cameras 18, position and motion sensors 22, and depth sensors 24 in FIG. 1.

During the operations of block 104, the electronic device may determine a first data set for a three-dimensional environment (e.g., an extended reality environment that includes the physical environment sensed during the operations of block 102) using at least the sensor data obtained during the operations of block 102. For example, depth sensor data and/or motion data from block 102 may be used to determine a spatial mesh for the first data set during the operations of block 104. Camera data from block 102 may be used to determine object color information and/or object type information (e.g., for physical objects in the physical environment) that is included in the first data set during the operations of block 104. Determining the first data set may also include determining information regarding one or more virtual objects in the extended reality environment. The first data set may sometimes be referred to as a scene understanding data set. The first data set may optionally be binned into a plurality of different groups associated with cubes of three-dimensional space within the XR environment.

During the operations of block 106, the electronic device may run a first application. The first application may be any desired type of application (e.g., a game application, a social media application, a productivity application, etc.).

During the operations of block 108, the electronic device may generate a second data set from the first data set based on spatial and/or temporal restrictions associated with the first application. The type of spatial and/or temporal restrictions used may be, for example, selected by a user when authorizing the first application to receive scene understanding data. The spatial restrictions may include a boundary around the electronic device. The boundary may be defined at least partially by a fixed radius around the electronic device, may be defined at least partially be the positions of physical walls in the physical environment, may be defined at least partially by line-of-sight distances to physical objects in the physical environment, and may be defined at least partially by user input. Data associated with locations within the boundary is included in the second data set whereas data associated with locations outside the boundary is not included in the second data set. The temporal restrictions may include a cutoff time. Data associated with times after the cutoff time (e.g., data that is recent) is included in the second data set whereas data associated with times before the cutoff time (e.g., data that is too old) is not included in the second data set.

The second data set may be generated using additive operations or subtractive operations. Generating the second data set via addition may include only adding data from the first data set associated with locations within the boundary to the second data set. Generating the second data set via subtraction may include copying the entire first data set and then removing data associated with locations outside the boundary. One or both of these techniques may sometimes be referred to as filtering the first data set to generate the second data set. Ultimately, the second data set includes a subset (and not all) of the data from the first data set based on spatial and/or temporal restrictions.

During the operations of block 110, the electronic device may provide only the second data set (from block 108) to the first application. The first application may use the second data set during operation of the first application.

During the operations of block 112, the electronic device may run a second application. The second application may be any desired type of application (e.g., a game application, a social media application, a productivity application, etc.). The second application is a different application than the first application.

During the operations of block 114, the electronic device may generate a third data set from the first data set based on spatial and/or temporal restrictions associated with the second application. The type of spatial and/or temporal restrictions used may be, for example, selected by a user when authorizing the second application to receive scene understanding data. The spatial restrictions may include a boundary around the electronic device. The boundary may be defined at least partially by a fixed radius around the electronic device, may be defined at least partially be the positions of physical walls in the physical environment, may be defined at least partially by line-of-sight distances to physical objects in the physical environment, and may be defined at least partially by user input. Data associated with locations within the boundary is included in the third data set whereas data associated with locations outside the boundary is not included in the third data set. The temporal restrictions may include a cutoff time. Data associated with times after the cutoff time (e.g., data that is recent) is included in the third data set whereas data associated with times before the cutoff time (e.g., data that is too old) is not included in the third data set.

The third data set may be generated using additive operations or subtractive operations, as discussed in connection with the second data set above. Ultimately, the third data set includes a subset (and not all) of the data from the first data set based on spatial and/or temporal restrictions.

The spatial and/or temporal restrictions for the third data set may be different than the spatial and/or temporal restrictions for the second data set.

During the operations of block 116, the electronic device may provide only the third data set (from block 114) to the second application. The second application may use the third data set during operation of the second application.

The example in FIG. 10 of electronic device 10 running the first and second applications at steps 106 and 112 is merely illustrative. If desired, electronic device 10 may apply temporal and/or spatial restrictions to a scene understanding data set based on one or more applications that are running on external electronic equipment (e.g., one or more additional electronic device). Electronic device 10 then provides the filtered scene understanding data to the application(s) running on the external electronic equipment.

The foregoing is merely illustrative and various modifications can be made to the described embodiments. The foregoing embodiments may be implemented individually or in any combination.

What is claimed is:

1. A method of operating an electronic device with one or more sensors in a physical environment, the method comprising:
obtaining, using the one or more sensors, sensor data for the physical environment;
determining a first data set for a three-dimensional environment using at least the sensor data;
running an application;
generating a second data set from the first data set based on spatial restrictions; and
providing only the second data set to the application.

2. The method defined in claim 1, wherein generating the second data set from the first data set based on spatial restrictions comprises including a first subset of the first data set in the second data set and wherein the first subset of the first data set is associated with locations inside a boundary.

3. The method defined in claim 2, wherein the boundary is defined by a fixed radius around the electronic device.

4. The method defined in claim 2, wherein the boundary is defined at least partially by line-of-sight distances to physical objects in the physical environment.

5. The method defined in claim 2, wherein the boundary is defined at least partially by user input.

6. The method defined in claim 2, wherein the first data set is binned into a plurality of different groups, wherein each group of the plurality of different groups has a respective centroid, and wherein the first subset of the first data set comprises each group that has a centroid inside the boundary.

7. The method defined in claim 1, wherein generating the second data set from the first data set based on spatial restrictions comprises removing a subset of the first data set that is associated with locations outside a boundary.

8. The method defined in claim 1, wherein the first data set comprises spatial mesh data and identities for one or more objects in the three-dimensional environment.

9. The method defined in claim 1, wherein the one or more sensors comprises one or more depth sensors and wherein the sensor data comprises depth sensor data.

10. The method defined in claim 1, wherein the one or more sensors comprises one or more cameras and wherein the sensor data comprises camera data.

11. The method defined in claim 1, wherein the one or more sensors comprises one or more accelerometers and wherein the sensor data comprises accelerometer data.

12. The method defined in claim 1, wherein the first data set comprises a three-dimensional representation of the physical environment.

13. The method defined in claim 1, wherein the electronic device further comprises a display that is configured to display a virtual object in the three-dimensional environment and wherein the first data set comprises data regarding the virtual object in the three-dimensional environment.

14. The method defined in claim 1, wherein generating the second data set comprises generating the second data set from the first data set based on spatial and temporal restrictions.

15. The method defined in claim 14, wherein generating the second data set comprises including a first subset of the first data set in the second data set and wherein the first subset of the first data set is associated with both locations inside a boundary and times after a cutoff time.

16. The method defined in claim 14, wherein generating the second data set comprises including a first subset of the first data set in the second data set and wherein the first subset of the first data set is associated with both locations inside a boundary and times before a cutoff time.

17. A method of operating an electronic device, the method comprising:
obtaining a first data set for a three-dimensional environment around the electronic device;
based on an application running, using the first data set to obtain a second data set by only including, in the second data set, data for portions of the three-dimensional environment associated with locations within a boundary; and
providing the second data set to the application.

18. The method defined in claim 17, further comprising:
based on an additional application running, using the first data set to obtain a third data set by only including, in the third data set, data for portions of the three-dimensional environment associated with locations within an additional boundary; and
providing the third data set to the additional application.

19. The method defined in claim 17, wherein using the first data set to obtain the second data set further comprises only including, in the second data set, data that is obtained at times after a cutoff time.

20. An electronic device operable in a physical environment, the electronic device comprising:
a head-mounted support structure;
one or more sensors coupled to the head-mounted support structure and configured to obtain sensor data for the physical environment; and
control circuitry configured to determine a first data set for a three-dimensional environment using at least the sensor data, generate a second data set from the first data set based on spatial restrictions, and provide only the second data set to an application.

21. The electronic device defined in claim 20, wherein generating the second data set from the first data set based on spatial restrictions comprises including a first subset of the first data set in the second data set and wherein the first subset of the first data set is associated with locations inside a boundary.
